(19) United States
(12) Patent Application Publication
(10) Pub. No.: US 2021/0062378 A1
(43) Pub. Date: Mar. 4, 2021

(54) Hydroentangled Nonwoven Fabrics Including Crimped Continuous Fibers

(71) Applicant: Berry Global, Inc., Evansville, IN (US)

(72) Inventors: Ralph A. Moody, III, Mooresville, NC (US); Andrew W. Delaney, Allentown, NJ (US); Michael McCloskey, East Windsor, NJ (US)

(21) Appl. No.: 17/010,061

(22) Filed: Sep. 2, 2020

Related U.S. Application Data
(60) Provisional application No. 62/895,161, filed on Sep. 3, 2019.

(51) Int. Cl. D04H 3/03; D02J 1/06; D04H 3/011; D02G 1/00

(52) U.S. Cl. CPC D04H 3/03; D02J 1/06; D04H 3/011; D10B 2331/04; D10B 2321/02; D10B 2331/02; D02G 1/008

(57) ABSTRACT

Nonwovens including a plurality of crimped continuous fibers (CCFs) that are physically entangled together, such by hydroentangling. Methods of forming a nonwoven including a plurality of physically entangled CCFs are also provided.

### CROSS-REFERENCE TO RELATED APPLICATIONS

This application claims priority under 35 U.S.C. § 119(e) to U.S. Provisional Application No. 62/895,161, filed Sep. 3, 2019, which is expressly incorporated by reference herein in its entirety.

### TECHNICAL FIELD

Embodiments of the presently-disclosed invention relate generally to nonwoven fabrics including a plurality of crimped continuous fibers (CCFs) that are physically entangled together, such as by hydroentanglement. Embodiments of the presently-disclosed invention also relate to methods of forming such nonwoven fabrics.

### BACKGROUND

Nonwoven fabrics including a plurality of physically entangled fibers, such as by hydroentanglement, are generally used in a variety of hygiene-related applications. Imaging of such nonwoven fabrics is often desirable.

Therefore, there remains a need in the art for nonwoven fabrics suitable, for example, for hygiene-related applications that are capable of receiving and/or maintaining a crisp three-dimensional image formed therein.

### SUMMARY OF INVENTION

One or more embodiments of the invention may address one or more of the aforementioned problems. Certain embodiments according to the invention provide nonwoven fabrics including a plurality of crimped continuous fibers (CCFs) that are physically entangled together, such as by hydroentangling. In accordance with certain embodiments of the invention, the nonwoven fabric may comprise or be implanted within a hygiene-related article (e.g., diaper), in which one or more of the components of the hygiene-related article comprises a nonwoven fabric as described and disclosed herein.

In another aspect the present invention provides a method of forming a nonwoven fabric as disclosed and described herein. In accordance with certain embodiments of the invention, for instance, the method may comprise forming or providing a first nonwoven or first nonwoven web comprising a first plurality of randomly deposited CCFs and physically entangling the first plurality of randomly deposited CCFs, such as by hydroentangling.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a CCR in accordance with certain embodiments of the invention;

FIG. 2A-2H illustrate examples of cross-sectional views for some example multi-component fibers in accordance with certain embodiments of the invention;

FIG. 3A shows an image of high-loft spunbond including a plurality of CCFs in accordance with certain embodiments of the invention;

FIG. 3B shows an image of a spunbond that does not include CCFs;

FIG. 4 shows an additional image of a high-loft spunbond including a plurality of CCFs in accordance with certain embodiments of the invention;

FIG. 5 illustrates an example output for a TSA analysis for a generic sample;

FIG. 6A shows an image of a sample produced in accordance with certain embodiments of the invention;

FIG. 6B and 6C each show an of a comparative nonwoven fabric; and

FIGS. 7A-7E show magnified images of the sample from FIG. 6A, which illustrates that the sample includes a plurality of CCFs with several helically-shaped crimped portions in accordance with certain embodiments of the invention.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to nonwoven fabrics including a plurality of crimped continuous fibers (CCFs) that are physically entangled together, such as by hydroentanglement. For example, hydroentangled nonwoven fabrics including a plurality of CCFs as disclosed herein surprisingly exhibit an enhanced three-dimensional imaging therein. Embodiments of the presently-disclosed invention also relate to methods of forming such nonwoven fabrics. In accordance with certain embodiments of the invention, the CCFs comprise one or more crimped portions located between adjacent discrete bond sites (e.g., thermal point bonds). In this regard, a precursor web (e.g., a web prior to being subjected to an imaging operation) including the CCFs may be easily extendable or elongated in one or more directions in the x-y plane due to the “slack” between adjacent discrete bond sites due to the crimped portions of the CCFs located between the adjacent first bond sites. In accordance with certain embodiments of the invention, the “slack” between adjacent discrete bond sites provides a greater degree of freedom for the portions of the CCFs located between bond sites to move and, for example, physically entangle together and/or with other fibers as well as to penetrate into an imaging surface during an imaging operation to provide an enhanced three-dimensional image into the nonwoven fabric. In accordance with certain embodiments of the invention, the nonwoven fabric may comprise a three-dimensional image imparted into at least a first surface of the nonwoven fabric, in which the three-dimensional image includes at least one recessed portion and at least one projecting portion. In accordance with certain embodiments of the invention, the enhanced image (e.g., greater resolution) may be realized visually as well as by a comparison of an increased thickness (e.g., caliper value) when compared to a comparative nonwoven fabric that is identically constructed, but does not include the CCFs.

The terms “substantial” or “substantially” may encompass the whole amount as specified, according to certain embodiments of the invention, or largely but not the whole amount specified (e.g., 95%, 96%, 97%, 98%, or 99% of the whole amount specified) according to other embodiments of the invention.

The terms “polymer” or “polymeric”, as used interchangeably herein, may comprise homopolymers, copolymers, such as, for example, block, graft, random, and alternating copolymers, terpolymers, etc., and blends and modifications thereof. Furthermore, unless otherwise specifically limited, the term “polymer” or “polymeric” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material. The term “polymer” or “polymeric” shall also include polymers made from various catalyst systems including, without limitation, the Ziegler-Natta catalyst system and the metallocene/single-site catalyst system. The term “polymer” or “polymeric” shall also include, in according to certain embodiments of the invention, polymers produced by fermentation process or biosourced.

The term “cellulosic fiber”, as used herein, may comprise fibers including or formed from natural cellulose, regenerated cellulose, and/or combinations thereof. For example, a “cellulosic fiber” may be derived from hardwood trees, softwood trees, or a combination of hardwood and softwood trees prepared for use in, for example, a papermaking furnish and/or fluff pulp furnish by any known suitable digestion, refining, and bleaching operations. The cellulosic fibers may comprise recycled fibers and/or virgin fibers. Recycled fibers differ from virgin fibers in that the fibers have gone through the drying process at least once. In certain embodiments, at least a portion of the cellulosic fibers may be provided from non-woody herbaceous plants including, but not limited to, kenaf, cotton, hemp, jute, flax, sisal, or abaca. Cellulosic fibers may, in certain embodiments of the invention, comprise either bleached or unbleached pulp fiber such as high yield pulps and/or mechanical pulps such as thermo-mechanical pulping (TMP), chemical-mechanical pulp (CMP), and bleached chemical-thermo-mechanical pulp BCTMP. In this regard, the term “pulp”, as used herein, may comprise cellulose that has been subjected to processing treatments, such as thermal, chemical, and/or mechanical treatments. Cellulosic fibers, according to certain embodiments of the invention, may comprise one or more pulp materials. In accordance with certain embodiments of the invention, the cellulosic fibers may comprise a rayon, such as viscose.

The terms “nonwoven” and “nonwoven web”, as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, needle-punching, hydroentangling, air-laid, and bonded carded web processes. A “nonwoven web”, as used herein, may comprise a plurality of individual fibers that have not been subjected to a bonding or consolidating process.

The terms “fabric” and “nonwoven fabric”, as used herein, may comprise a web of fibers in which a plurality of the fibers are mechanically entangled or interconnected, fused together, or chemically bonded together. For example, a nonwoven web of individually laid fibers may be subjected to a bonding or consolidation process to mechanically entangle, or otherwise bond, at least a portion of the individually fibers together to form a coherent (e.g., united) web of interconnected fibers.

The term “consolidated” and “consolidation”, as used herein, may comprise the bringing together of at least a portion of the fibers of a nonwoven web into closer proximity or attachment there-between (e.g., thermally fused together, chemically bonded together, or mechanically entangled together) to form a bonding site, or bonding sites, which function to increase the resistance to external forces (e.g., abrasion and tensile forces), as compared to the unconsolidated web. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, or mechanically entangled together), such as by thermal bonding or mechanical entanglement (e.g., hydroentanglement) as merely a few examples. Such a web may be considered a “consolidated nonwoven”, “nonwoven fabric” or simply as a “fabric” according to certain embodiments of the invention.

The term “staple fiber”, as used herein, may comprise a cut fiber from a filament. In accordance with certain embodiments, any type of filament material may be used to form staple fibers. For example, staple fibers may be formed from polymeric fibers, and/or elastomeric fibers. Non-limiting examples of materials may comprise polyolefins (e.g., a polypropylene or polypropylene-containing copolymer), polyethylene terephthalate, and polyamides. The average length of staple fibers may comprise, by way of example only, from about 2 centimeter to about 15 centimeter.

The term “layer”, as used herein, may comprise a generally recognizable combination of similar material types and/or functions existing in the X-Y plane.

The term “multi-component fibers”, as used herein, may comprise fibers formed from at least two different polymeric materials or compositions (e.g., two or more) extruded from separate extruders but spun together to form one fiber. The term “bi-component fibers”, as used herein, may comprise fibers formed from two different polymeric materials or compositions extruded from separate extruders but spun together to form one fiber. The polymeric materials or polymers are arranged in a substantially constant position in distinct zones across the cross-section of the multi-component fibers and extend continuously along the length of the multi-component fibers. The configuration of such a multi-component fiber may be, for example, a sheath/core arrangement wherein one polymer is surrounded by another, an eccentric sheath/core arrangement, a side-by-side arrangement, a pie arrangement, or an “islands-in-the-sea” arrangement, each as is known in the art of multicomponent, including bicomponent, fibers.

The term “machine direction” or “MD”, as used herein, comprises the direction in which the fabric produced or conveyed. The term “cross-direction” or “CD”, as used herein, comprises the direction of the fabric substantially perpendicular to the MD.

The term “crimp” or “crimped”, as used herein, comprises a three-dimensional curl or bend such as, for example, a folded or compressed portion having an “L” configuration, a wave portion having a “zig-zag” configuration, or a curl portion such as a helical configuration. In accordance with certain embodiments of the invention, the term “crimp” or “crimped” does not include random two-dimensional waves or undulations in a fiber, such as those associated with normal lay-down of fibers in a melt-spinning process.

The term “polydispersity”, as used herein, comprises the ratio of a polymeric material's mass weighted molecular weight (M_{w}) to the number weighted molecular weight (Mₙ)−M_{w}/Mₙ.

The term “high-loft”, as used herein, comprises a material that comprises a z-direction thickness generally in excess of about 0.3 mm and a relatively low bulk density. The thickness of a “high-loft” nonwoven and/or layer may be greater than 0.3 mm (e.g., greater than 0.4 mm. greater than 0.5 mm, or greater than 1 mm) as determined utilizing a ProGage Thickness tester (model 89-2009) available from Thwig-Albert Instrument Co. (West Berlin, N.J. 08091), which utilizes a 2″ diameter foot, having a force application of 1.45 kPa during measurement. In accordance with certain embodiments of the invention, the thickness of a “high-loft” nonwoven and/or layer may be at most about any of the following: 3, 2.75, 2.5, 2.25, 2, 1.75, 1.5, 1.25, 1.0, 0.75, and 0.5 mm and/or at least about any of the following: 0.3, 0.4, 0.5, 0.75, 1.0, 1.25, 1.5, 1.75, and 2.0 mm. “High-loft” nonwovens and/or layers, as used herein, may additionally have a relatively low density (e.g., bulk density—weight per unit volume), such as less than about 60 kg/m³, such as at most about any of the following: 70, 60, 55, 50, 45, 40, 35, 30, and 25 kg/m³ and/or at least about any of the following: 10, 15, 20, 25, 30, 35, 40, 45, 50, and 55 kg/m³.

As used herein, the term “continuous fibers” refers to fibers which are not cut from their original length prior to being formed into a nonwoven web or nonwoven fabric. Continuous fibers may have average lengths ranging from greater than about 15 centimeters to more than one meter, and up to the length of the web or fabric being formed. For example, a continuous fiber, as used herein, may comprise a fiber in which the length of the fiber is at least 1,000 times larger than the average diameter of the fiber, such as the length of the fiber being at least about 5,000, 10,000, 50,000, or 100,000 times larger than the average diameter of the fiber.

As used herein, the term “aspect ratio”, comprise a ratio of the length of the major axis to the length of the minor axis of the cross-section of the fiber in question.

All whole number end points disclosed herein that can create a smaller range within a given range disclosed herein are within the scope of certain embodiments of the invention. By way of example, a disclosure of from about 10 to about 15 includes the disclosure of intermediate ranges, for example, of: from about 10 to about 11; from about 10 to about 12; from about 13 to about 15; from about 14 to about 15; etc. Moreover, all single decimal (e.g., numbers reported to the nearest tenth) end points that can create a smaller range within a given range disclosed herein are within the scope of certain embodiments of the invention. By way of example, a disclosure of from about 1.5 to about 2.0 includes the disclosure of intermediate ranges, for example, of: from about 1.5 to about 1.6; from about 1.5 to about 1.7; from about 1.7 to about 1.8; etc.

In one aspect, the invention provides nonwoven fabrics including a plurality of crimped continuous fibers (CCFs) that are physically entangled together, such as by hydroentangling. In accordance with certain embodiments of the invention, the nonwoven fabric may comprise or be implanted within a hygiene-related article (e.g., diaper), in which one or more of the components of the hygiene-related article comprises a nonwoven fabric as described and disclosed herein. In accordance with certain embodiments of the invention, the CCFs may comprise spunbond fibers, meltblown fibers, or combinations thereof. The CCFs may comprise mono-component fibers, multi-component fibers (e.g., bi-component fibers), or combinations thereof. As discussed in more detail below, the nonwoven fabrics may comprise one or more of the following groups of fibers: a first group of CCFs; a second group of CCFs; crimped non-continuous fibers; non-crimped fibers (e.g., continuous or non-continuous), in which the fibers from each group of fibers are physically entangled with each other to provide a unitary nonwoven fabric.

In accordance with certain embodiments of the invention, the CCFs may comprise self-crimped multi-component fibers comprising (i) a first component comprising a first polymeric material having a first melt flow rate (MFR), such as less than 50 g/10 min; and (ii) a second component comprising a second polymeric material that is different than the first component; wherein the CCFs comprises one or more three-dimensional crimped portions; and wherein optionally the second polymeric material comprises a second MFR that is, for example, less than 50 g/10 min. Additionally or alternatively, the CCFs may comprise post-crimped multi-component fibers and/or mono-component fibers, such as by mechanical formation or thermal formation of the crimps after being laid-down on a collection belt. In accordance with certain embodiment of the invention, for instance, the nature in which the crimps are imparted to the continuous fibers is not particularly limited.

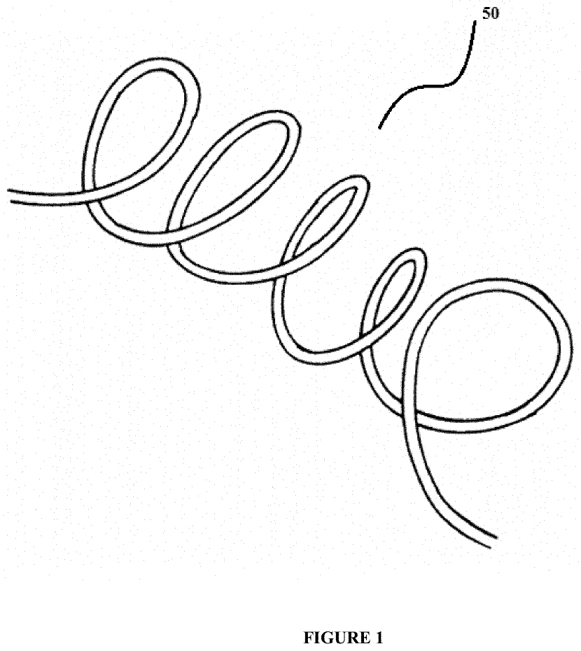

FIG. 1, for instance, illustrates a CCF 50 in accordance with certain embodiments of the invention, in which the CCF 50 includes plurality of three-dimensional coiled or helically shaped crimped portions. The CCF 50 of figure one may comprise a mono-component or multi-component fiber (e.g., a bi-component fiber) in accordance with certain embodiments of the invention.

In accordance with certain embodiments of the invention, the CCFs may comprise an average free crimp percentage from about 50% to about 300%, such as at most about any of the following: 300, 275, 250, 225, 200, 175, 150, 125, 100, and 75% and/or at least about any of the following: 50, 75, 100, 125, 150, 175, and 200%. The CCFs, in accordance with certain embodiments of the invention, may include a plurality of discrete zig-zag configured crimped portions, a plurality of discrete or continuously coiled or helically configured crimped portions, or a combination thereof. The average free crimp percentage may be ascertained by determining the free crimp length of the fibers in question with an Instron 5565 equipped with a 2.5N load cell. In this regard, free or unstretched fiber bundles may be placed into clamps of the machine. The free crimp length can be measured at the point where the load (e.g., 2.5 N load cell) on the fiber bundle becomes constant. The following parameters are used to determine the free crimp length: (i) Record the Approximate free fibers bundle weight in grams (e.g., xxx g±0.002 grams); (ii) Record the Unstretched bundle length in inches; (iii) Set the Gauge Length (i.e., the distance or gap between the clamps holding the bundle of fibers) of the Instron to 1 inch; and (iv) Set the Crosshead Speed to 2.4 inches/minute. The free crimp length of the fibers in question may then be ascertained by recording the extension length of the fibers at the point where the load becomes constant (i.e., the fibers are fully extended). The average free crimp percentage may be calculated from the free crimp length of the fibers in question and the unstretched fiber bundles length (e.g., the gauge length). For example, a measured free crimp length of 32 mm when using a 1 inch (25.4 mm) gauge length as discussed above would provide an average free crimp percentage of about 126%. The foregoing method to determine the average free crimp percentage may be particularly beneficial when evaluating continuous fibers having helically coiled crimps. For instance, traditional textile fibers are mechanically crimped and can be measured optically but continuous fibers having helically coiled crimped portions cause errors in trying to optically count “crimp” in such fibers.

In accordance with certain embodiments of the invention, the CCFs may comprise a plurality of three-dimensional crimped portions having an average diameter (e.g., based on the average of the longest length defining an individual crimped portion) from about 0.5 mm to about 5 mm, such as at most about any of the following: 5, 4.75, 4.5, 4.25, 4, 3.75, 3.5, 3.25, 3, 2.9, 2.8, 2.7, 2.6, 2.5, 2.4, 2.3, 2.2, 2.1, 2, 1.9, 1.8, 1.7, 1.6, and 1.5 mm and/or at least about any of the following: 0.5, 0.6, .07, 0.8, 0.9, 1, 1.1, 1.2, 1.3, 1.4, 1.5, 1.6, 1.7, 1.8, 1.9, and 2 mm. In accordance with certain embodiments of the invention, the average diameter of the plurality of three-dimensional crimped portions can be ascertained by use of a digital optical microscope (Manufactured by HiRox in Japan KH-7700) to view CCF samples and obtain digital measurement of loop diameters of the three-dimensional crimped portions of the CCFs. Magnification ranges generally in the 20× to 40× can be used to ease evaluation of the loop diameter formed from the three-dimensional crimping of the CCFs.

The CCFs may comprise a variety of cross-sectional geometries and/or deniers, such as round or non-round cross-sectional geometries. In accordance with certain embodiments of the invention, a plurality of CCFs may comprise all or substantially all of the same cross-sectional geometry or a mixture of differing cross-sectional geometries to tune or control various physical properties. In this regard, a plurality of CCFs may comprise a round cross-section, a non-round cross-section, or combinations thereof. In accordance with certain embodiments of the invention, for example, a plurality of CCFs may comprise from about 10% to about 100% of round cross-sectional fibers, such as at most about any of the following: 100, 95, 90, 85, 75, and 50% and/or at least about any of the following: 10, 20, 25, 35, 50, and 75%. Additionally or alternatively, a plurality of CCFs from about 10% to about 100% of non-round cross-sectional fibers, such as at most about any of the following: 100, 95, 90, 85, 75, and 50% and/or at least about any of the following: 10, 20, 25, 35, 50, and 75%. In accordance with embodiments of the invention including non-round cross-sectional CCFs, these non-round cross-sectional CCFs may comprise an aspect ratio of greater than 1.5:1, such as at most about any of the following: 10:1, 9:1, 8:1, 7:1, 6:1, 5:1, 4:1, 3:1, and 2:1 and/or at least about any of the following: 1.5:1, 2:1, 2.5:1, 3:1, 4:1, 5:1, and 6:1. In accordance with certain embodiments of the invention, the aspect ratio, as used herein, may comprise a ratio of the length of the major axis to the length of the minor axis of the cross-section of the fiber in question. In accordance with certain embodiments of the invention, a plurality of CCFs may be admixed or blended with non-crimped fibers (e.g., mono-component and/or multi-component fibers) in a single layer of a nonwoven web.

In accordance with certain embodiments of the invention, a CCF may comprise a sheath/core configuration, a side-by-side configuration, a pie configuration, an islands-in-the-sea configuration, a multi-lobed configuration, or any combinations thereof. In accordance with certain embodiments of the invention, the sheath/core configuration may comprise an eccentric sheath/core configuration (e.g., bi-component fiber) including a sheath component and core component that is not concentrically located within the sheath component. The core component, for example, may define at least a portion of an outer surface of the CCF having the eccentric sheath/core configuration in accordance with certain embodiments of the invention.

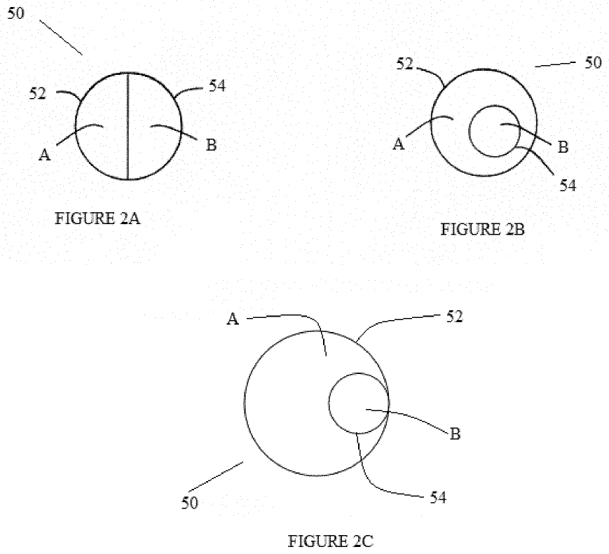

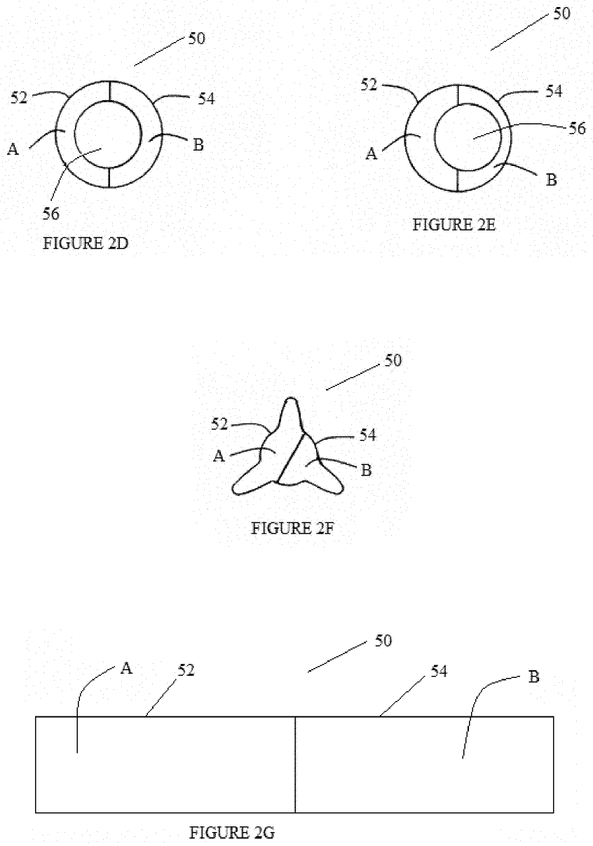

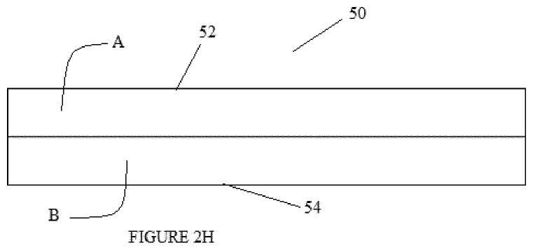

FIGS. 2A-2H illustrate examples of cross-sectional views for some non-limiting examples of CCFs in accordance with certain embodiments of the invention. As illustrated in FIG. 2A-2H, the CCF 50 may comprise a first polymeric component 52 of a first polymeric composition A and a second polymeric component 54 of a second polymeric composition B. The first and second components 52 and 54 can be arranged in substantially distinct zones within the cross-section of the CCF that extend substantially continuously along the length of the CCF. The first and second components 52 and 54 can be arranged in a side-by-side arrangement in a round cross-sectional fiber as depicted in FIG. 2A or in a ribbon-shaped (e.g., non-round) cross-sectional fiber as depicted in FIGS. 2G and 2H. Additionally or alternatively, the first and second components 52 and 54 can be arranged in a sheath/core arrangement, such as an eccentric sheath/core arrangement as depicted in FIGS. 2B and 2C. In the eccentric sheath/core CCFs as illustrated in FIG. 2B, one component fully occludes or surrounds the other but is asymmetrically located in the CCF to allow fiber crimp (e.g., first component 52 surrounds component 54). Eccentric sheath/core configurations as illustrated by FIG. 2C include the first component 52 (e.g., the sheath component) substantially surrounding the second component 54 (e.g., the core component) but not completely as a portion of the second component may be exposed and form part of the outermost surface of the fiber 50. As additional examples, the CCFs can comprise hollow fibers as shown in FIGS. 2D and 2E or as multilobal fibers as shown in FIG. 2F. It should be noted, however, that numerous other cross-sectional configurations and/or fiber shapes may be suitable in accordance with certain embodiments of the invention. In the multi-component fibers, in accordance with certain embodiments of the invention, the respective polymer components can be present in ratios (by volume or by mass) of from about 85:15 to about 15:85. Ratios of approximately 50:50 (by volume or mass) may be desirable in accordance with certain embodiments of the invention; however, the particular ratios employed can vary as desired, such as at most about any of the following: 85:15, 80:20, 75:25, 70:30, 65:35, 60:40, 55:45 and 50:50 by volume or mass and/or at least about any of the following: 50:50, 45:55, 40:60, 35:65, 30:70, 25:75, 20:80, and 15:85 by volume or mass.

As noted above, the CCFs may comprise a first component comprising a first polymeric composition and a second component comprising a second polymeric composition, in which the first polymeric composition is different than the second polymeric composition. For example, the first polymeric composition may comprise a first polyolefin composition and the second polymeric composition may comprise a second polyolefin composition. In accordance with certain embodiments of the invention, the first polyolefin composition may comprise a first polypropylene or blend of polypropylenes and the second polyolefin composition may comprise a second polypropylene and/or a second polyethylene, in which the first polypropylene or blend of polypropylenes has, for example, a melt flow rate that is less than 50 g/10 min. Additionally or alternatively, the first polypropylene or blend of polypropylenes may have a lower degree of crystallinity than the second polypropylene and/or a second polyethylene. In accordance with certain embodiments of the invention, the second polymeric composition, may comprise a polyester, a polyamide, or a bio-polymer (e.g., polylactic acid).

In accordance with certain embodiments of the invention, the first polymeric composition and the second polymeric composition can be selected so that the multi-component fibers develop one or more crimps therein without additional application of heat either in the diffuser section just after the draw unit but before laydown, once the draw force is relaxed, and/or post-treatments such as after fiber lay down and web formation. The polymeric compositions, therefore, may comprise polymers that are different from one another in that they have disparate stress or elastic recovery properties, crystallization rates, and/or melt viscosities. In accordance with certain embodiments of the invention, the polymeric compositions may be selected to self-crimp (e.g., a post-crimping operation may not be necessary after the laydown of the fibers from a spinneret) by virtue of the melt flow rates of the first and second polymeric compositions as described and disclosed herein. In accordance with certain embodiments of the invention, multi-component fibers, for example, can form or have crimped fiber portions having a helically-shaped crimp in a single continuous direction. For example, one polymeric composition may be substantially and continuously located on the inside of the helix formed by the crimped nature of the fiber.

In accordance with certain embodiments of the invention, for example, the first polymeric composition of the first component may comprise a first MFR from about 20 g/10 min to less than 50 g/10 min, such as at most about any of the following: 50, 48, 46, 44, 42, 40, 38, 36, 35, 34, 32, and 30 g/10 min and/or at least about any of the following: 20, 22, 24, 25, 26, 28, 30, 32, 34, and 35 g/10 min. In accordance with certain embodiments of the invention, the second polymeric composition of the second component may comprise a second MFR from about 20 g/10 min to about 48 g/10 min, such as at most about any of the following: 48, 46, 44, 42, 40, 38, 36, 35, 34, 32, and 30 g/10 min and/or at least about any of the following: 20, 22, 24, 25, 26, 28, 30, 32, 34, and 35 g/10 min. In accordance with certain embodiments of the invention, the difference in the MFR between the first polymeric composition and the second polymeric composition may comprise from about 8 g/10 min to about 30 g/10 min, such as at most about any of the following: 30, 28, 26, 25, 24, 22, 20, 18, 16, 15, 14, 12, 10, and 8 g/10 min and/or at least about any of the following: 8, 10, 12, 14, and 15 g/10 min.

In accordance with certain embodiments of the invention, the nonwoven fabric may comprise, for example, (i) a first group of CCFs having a first identifying feature, such as a first cross-sectional geometry, a first chemical construction or composition, or a first free crimp percentage, and (ii) a second group of CCFs having a second identifying feature, such as a second cross-sectional geometry, a second chemical construction of composition, or a second free crimp percentage; wherein the first identifying feature is different than the second identifying feature. The first group of CCFs, for example, may include a polyolefin as at least a portion thereof (e.g., a component of a multi-component fiber), and the second group of CCFs include a different polyolefin composition or a non-polyolefin as at least a portion thereof.

In accordance with certain embodiments of the invention, the nonwoven fabric may also include a plurality of non-crimped fibers physically entangled together with the CCFs. For example, the plurality of non-crimped fibers may comprise spunbond fibers, meltblown fibers, staple fibers, cellulosic fibers (e.g., fibers comprising or formed from natural and/or regenerated cellulose), or combinations thereof. In accordance with certain embodiments of the invention, the plurality of non-crimped fibers may comprise a biopolymer, such as polylactic acid (PLA), polyhydroxyalkanoates (PHA), and poly(hydroxycarboxylic) acids; wherein the plurality of non-crimped fibers is physically entangled together with the plurality of CCFs. In accordance with certain embodiments of the invention, the plurality of non-crimped fibers may comprise a synthetic polymer. The synthetic polymer, for example, may comprises a polyolefin, a polyester, a polyamide, or any combination thereof. By way of example only, the synthetic polymer may comprise at least one of a polyethylene, a polypropylene, a partially aromatic or fully aromatic polyester, an aromatic or partially aromatic polyamide, an aliphatic polyamide, or any combination thereof. Additionally or alternatively, the second nonwoven layer may comprise a natural and/or regenerated cellulosic fibers. In accordance with certain embodiments of the invention, the cellulosic fibers may comprise a rayon, such as viscose, either alone or in combination with a natural cellulose (e.g., a pulp). In accordance, with certain embodiments of the invention, the at least a portion or all of the cellulosic fibers may comprise staple fibers.

The nonwoven fabric, in accordance with certain embodiments of the invention, may include a first outer surface, a second outer surface, and an interior region including a mid-point between the first outer surface and the second outer surface in the z-direction. In accordance with certain embodiments of the invention, a first concentration of the plurality of non-crimped fibers, such as cellulosic fibers, at the first outer surface and/or the second outer surface is less than a second concentration of the plurality of the non-crimped fibers at the mid-point. In accordance with certain embodiments of the invention, for example, a majority (e.g., more than 50% by number) of the plurality of non-crimped fibers, such as cellulosic fibers, reside in the interior region, such at least about 60%, 70%, or 80% by number.

In accordance with certain embodiments of the invention, the nonwoven fabrics comprise a cross-direction, a machine direction, and a z-direction thickness. In accordance with certain embodiments of the invention, the nonwoven fabric may comprise a high-loft nonwoven fabric having a loftiness in the z-direction thickness from at most about any of the following: 3, 2.75, 2.5, 2.25, 2, 1.75, 1.5, 1.25, 1.0, 0.75, and 0.5 mm and/or at least about any of the following: 0.3, 0.4, 0.5, 0.75, 1.0, 1.25, 1.5, 1.75, and 2.0 mm. Additionally or alternatively, the nonwoven fabric may have a bulk density less than about 70 kg/m³, such as at most about any of the following: 70, 60, 55, 50, 45, 40, 35, 30, and 25 kg/m³ and/or at least about any of the following: 10, 15, 20, 25, 30, 35, 40, 45, 50, and 55 kg/m³.

In accordance with certain embodiments of the invention, the nonwoven fabric may further comprise a plurality of thermal bonds, in which the CCFs include at least one crimped portion located between a first thermal bond and a second thermal bond. For instance, the at least one crimped portion may comprise one or more three-dimensional crimped portions having, for example, at least one discrete zig-zag configured crimped portion, at least one discrete helically configured crimped portion, or a combination thereof.

In accordance with certain embodiments of the invention, the nonwoven fabric may comprise a bonded area defined by the thermal bonds, in which the thermal bonds comprise a plurality of discrete first bond sites. For example, the first plurality of discrete first bond sites may comprise thermal point bonds. In accordance with certain embodiments of the invention, the plurality of discrete bond sites may comprise an average distance between adjacent bond sites from about 1 mm to about 10 mm, such as at most about any of the following: 10, 9, 8, 7, 6, 5, 4, 3.5, 3, and 2 mm and/or at least about any of the following: 1, 1.5, 2, 2.5, and 3 mm. Additionally or alternatively, the plurality of discrete bond sites may comprise an average area from about 0.25 mm² to about 3 mm², such as at most about any of the following: 3, 2.5, 2.25, 2, 1.75, 1.5, 1.25, 1, and 0.75 mm² and/or at least about any of the following: 0.25, 0.3, 0.4, 0.5, 0.6, 0.7, 0.75, 0.8, 0.9, 1, and 1.25 mm². In accordance with certain embodiments of the invention, the CCFs comprise one or more crimped portions located between adjacent discrete bond sites. In this regard, a precursor web including the CCFs and described and disclosed herein may be easily extendable or elongated in one or more directions in the x-y plane due to the “slack” between adjacent discrete bond sites due to the crimped portions of the CCFs located between the adjacent first bond sites. In accordance with certain embodiments of the invention, the “slack” between adjacent discrete bond sites provides a greater degree of freedom for the portions of the CCFs located between bond sites to move and, for example, physically entangle together and/or with other fibers as well as to penetrate into an imaging surface during an imaging operation to provide an enhanced three-dimensional image into the nonwoven fabric. In accordance with certain embodiments of the invention, the nonwoven fabric may comprise a three-dimensional image imparted into at least a first surface of the nonwoven fabric, in which the three-dimensional image includes at least one recessed portion and at least one projecting portion.

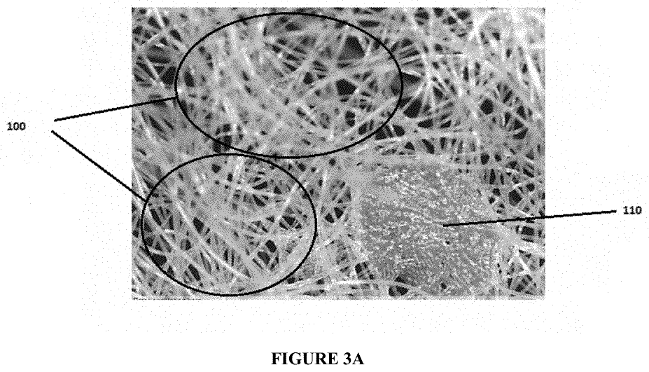

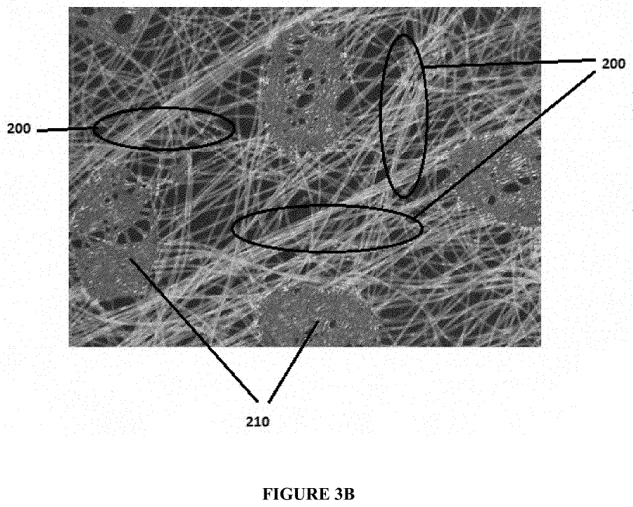

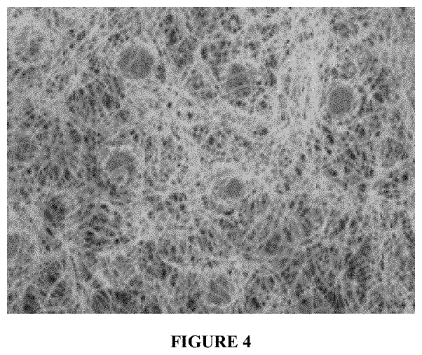

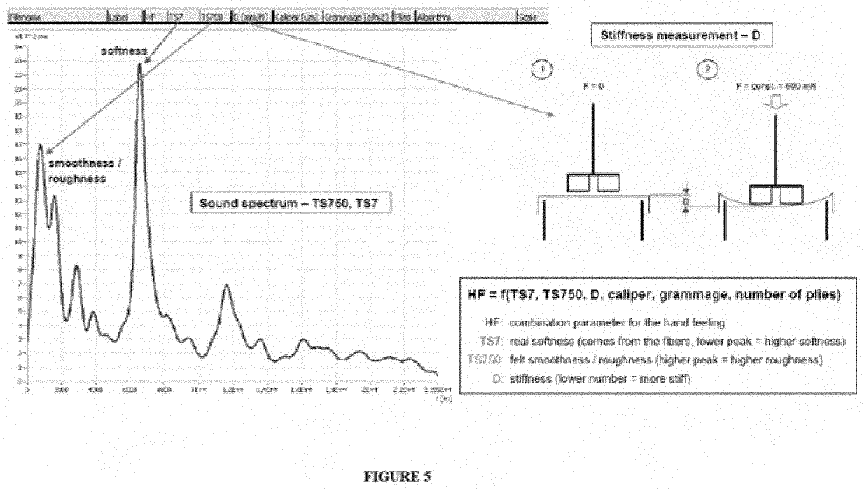

FIG. 3A, for example, shows an image of high-loft spunbond including a plurality of CCFs in accordance with certain embodiments of the invention. As can be seen in FIG. 3A, the CCFs include several crimped portions 100 (e.g., helical crimped portions) between thermal point bonds 110. FIG. 3B shows an image of a spunbond that does not include CCFs, in which the unbonded portions 200 between thermal point bonds 210 as significantly more linear and do not include any crimped portions. As such, the fibers of the nonwoven fabric shown in FIG. 3B lack the degree of freedom that is realized by the CCFs shown in FIG. 3A. FIG. 4 shows an additional image of a high-loft spunbond including a plurality of CCFs in accordance with certain embodiments of the invention.

In accordance with certain embodiments of the invention, the nonwoven fabric may comprise a basis weight from about from about 5 to about 200 gsm, such as at most about any of the following: 200, 150, 100, 75, 50, 40, 30, 25, 20, 15, 12, 10, 8, and 5 gsm and/or at least about any of the following: 5, 8, 10, 12, 15, 20, 30, 40, and 50 gsm.

In accordance with certain embodiments of the invention, the nonwoven fabric including a plurality of CCFs may comprise an increased thickness as compared to a comparative nonwoven fabric that does not include any CCFs, but otherwise is identically constructed. For example, the nonwoven fabric including a plurality of CCFs may comprise a thickness that is at least 1.25 times larger than that of the comparative nonwoven fabric, such as at most about any of the following: 3, 2.5, 2, 1.8, 1.6, 1.5, and 1.4 times larger than that of the comparative nonwoven fabric and/or at least about any of the following: 1.2, 1.25, 1.3, 1.35, 1.4, 1.45, and 1.5 times larger than that of the comparative nonwoven fabric.

In accordance with certain embodiments of the invention, the nonwoven fabric including a plurality of CCFs may comprise a reduced bulk density as compared to a comparative nonwoven fabric that does not include any CCFs, but otherwise is identically constructed. For example, the nonwoven fabric including a plurality of CCFs may comprise a bulk density that is at least 20% less than that of the comparative nonwoven fabric, such as at most about any of the following: 70, 60, 50, 40, and 30% less than that of the comparative nonwoven fabric and/or at least about any of the following: 10, 15, 20, 25, 30, 35, and 40% less than that of the comparative nonwoven fabric.

In yet another aspect, the presently-disclosed invention provides a method of forming a nonwoven fabric as disclosed and described herein. In accordance with certain embodiments of the invention, for instance, the method may comprise forming or providing a first nonwoven or first nonwoven web (e.g., a non-consolidated web of fibers) comprising a first plurality of randomly deposited CCFs and physically entangling the first plurality of randomly deposited CCFs, such as by hydroentangling.

In accordance with certain embodiments of the invention, the method may comprise (a) providing a three-dimensional image transfer device having an imaging surface, (b) supporting the first nonwoven or first nonwoven web directly or indirectly on the imaging surface of the three-dimensional image transfer device, and (c) directly or indirectly imaging the nonwoven by subjecting at least a first side of the first nonwoven or first nonwoven web to jets of fluid at a pressure sufficient to physically entangle the first plurality of randomly deposited CCFs and to impart a three-dimensional image into the nonwoven. In accordance with certain embodiments of the invention, the method may comprise superimposing the first nonwoven or first nonwoven web with at least a second layer of fibers prior to physically entangling the first plurality of randomly deposited CCFs. For example, the second layer of fibers may comprise a second plurality of randomly deposited CCFs, a second group of non-crimped fibers, or a combination thereof. In accordance with certain embodiments of the invention, the first plurality of randomly deposited CCFs and the second layer of fibers are physically entangled together, such as by hydroentangling.

In accordance with certain embodiments of the invention, the method may additionally or alternatively comprise superimposing (a) the first nonwoven or first nonwoven web, (b) the second layer of fibers, and (c) a third layer of fibers, in which the third layer of fibers comprises a third plurality of randomly deposited CCFs, a third non-crimped fibers, or a combination thereof. In accordance with certain embodiments of the invention, the first plurality of randomly deposited CCFs, the second layer of fibers, and the third layer of fibers are physically entangled together to provide a unitary nonwoven fabric. In accordance with certain embodiments of the invention, the second layer of fibers may be positioned between the nonwoven or first nonwoven web and the third layer of fibers, in which the second layer of fibers comprise cellulosic fibers.

In accordance with certain embodiments of the invention, the method may comprise forming a precursor web via physically entangling the first plurality of randomly deposited CCFs of the first nonwoven or first nonwoven web together with at least the second layer of fibers. In accordance with certain embodiments of the invention, the method may further comprise imaging the precursor web by subj ecting at least a first side of the precursor web to jets of fluid (e.g., water) at a pressure sufficient to (a) further physically entangle the first plurality of randomly deposited CCFs and the second layer of fibers, and (b) to impart a three-dimensional image into the nonwoven from the imaging surface of the imaging device. In accordance with certain embodiments of the invention, the first plurality of randomly deposited CCFs of the first nonwoven or first nonwoven web may be directly impacted by the jets of fluid. In accordance with certain embodiments of the invention, the first plurality of randomly deposited CCFs of the first nonwoven or first nonwoven web are positioned in direct contact with the imaging surface of the three-dimensional image transfer device.

In accordance with certain embodiments of the invention, suitable three-dimensional imaging devices may comprise imaging sleeves include those described, for example, in RE38,105 and RE38,505, in which the contents of both are hereby incorporated by reference in their entirety. For example, the nonwoven fabric may include a three-dimensional image formed therein that may be formed throughout the nonwoven fabric. For example, the image transfer device may comprise one or more drums or even one or more sleeves affixed to a corresponding drum. One or more water jets, for example, may be applied to a side of the nonwoven opposite to the side contacting the image transfer device. Without intending to be bound by the theory, the one or more water jets and water directed through the nonwoven causes the fibers of the nonwoven to become displaced according to the image on the image transfer device such as the image formed on one or more drums or one or more sleeves affixed to a corresponding drum causing a three-dimensional pattern to be imaged throughout the nonwoven according to such image. Such imaging techniques are further described in, for example, U.S. Pat. No. 6,314,627 entitled “Hydroentangled Fabric having Structured Surfaces”; U.S. Pat. No. 6,735,833 entitled “Nonwoven Fabrics having a Durable Three-Dimensional Image”; U.S. Pat. No. 6,903,034 entitled “Hydroentanglement of Continuous Polymer Filaments”; U.S. Pat. No. 7,091,140 entitled “Hydroentanglement of Continuous Polymer Filaments”; and U.S. Pat. No. 7,406,755 entitled “Hydroentanglement of Continuous Polymer Filaments” each of which are hereby incorporated by reference in their entirety herein by reference.

In another aspect, the present invention provides a hygiene-related article (e.g., diaper), in which one or more of the components of the hygiene-related article comprises a nonwoven fabric as described and disclosed herein. Nonwoven fabric, in accordance with certain embodiments of the invention, may be incorporated into infant diapers, adult diapers, and femcare articles (e.g., as or as a component of a topsheet, a backsheet, a waistband, as a legcuff, etc.).

### EXAMPLES

The present disclosure is further illustrated by then following examples, which in no way should be construed as being limiting. That is, the specific features described in the following examples are merely illustrative and not limiting.

Five (5) different nonwoven fabrics were formed to evaluate and compare physical properties associated with certain embodiments of the invention to those of comparative nonwoven fabrics that do not include any CCFs. All samples were thermal calendered with a U5714 open dot bond pattern prior to hydroentanglement to ensure an identical bonding area and pattern across all samples prior to hydroentanglement. All samples were subjected to hydroentanglement on a hydroentangling imaging pilot line with 1100 psi waterjet strip (3 passes) at a speed of 200 fpm to physically entangle the fibers and to impart an image therein. All processing conditions were identical for all samples.

Sample 1 was a comparative nonwoven fabric formed in accordance with U.S. Pat. No. 6,735,833. Sample 1 was formed by hydroentangling and imaging a 10 gsm polypropylene spunbond and a 30 gsm PET carded web.

Sample 2 was a nonwoven fabric formed by hydroentangling two layers of spunbond high-loft layers. Each spunbond high-loft layer comprised 20 gsm. Each spunbond layer was formed from three beams. The first beam and third beam each comprised side-by-side (polypropylene/co-polypropylene) crimped fibers. The second beam comprised polypropylene/polyethylene bi-component crimped fibers. In this regard, Sample 2 consisted of 100% CCFs.

Sample 3 was identical to that of Sample 2, with the exception that all layers were formed from side-by-side (60% Exxon 3155 polypropylene/40% random copolymer of polypropylene 35R80 from Propilco) crimped fibers. In this regard, Sample 3 also consisted of 100% CCFs.

Sample 4 was a comparative nonwoven fabric formed from hydroentangling four spunbond layers, in which each spunbond layer was 10 gsm and formed from polypropylene. Sample 4 was devoid of CCFs.

Sample 5 was a comparative nonwoven fabric formed from hydroentangling two spunbond layers, in which each spunbond layer was 19 gsm and formed from polypropylene. Sample 5 was devoid of CCFs.

Table 1 provides a summary of softness data as determined with a TSA—Tissue Softness Analyzer from Emtec Innovative Testing Solutions and other physical data (e.g., density, thickness, etc.). In this regard, the “T57” data is a direct measurement of the softness of the sample (e.g., via measurement of blade vibration by the TSA device due to the stiffness of the fibers) and the “TS750” data is a direct measurement of the samples roughness (e.g., via measurement of vertical vibrations from the sample by the TSA device due to horizontal blade movement across the surface of the sample. The “D” data is a direct measurement of the stiffness of the sample by the TSA device due to the sample deformation under a defined force. The “HF” values are composite values based on the “T57” data, the “TS750” data, and the “D” data. The “HF” values provide an objective evaluation of the samples overall hand-feel. FIG. 5 illustrates an example output for a TSA analysis for a generic sample.

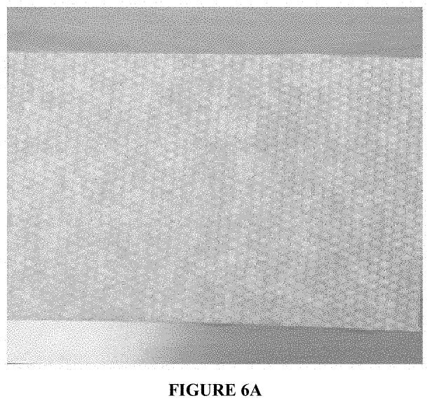

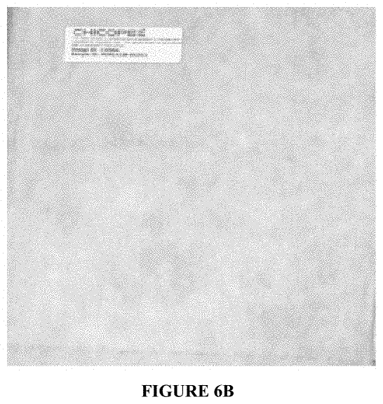

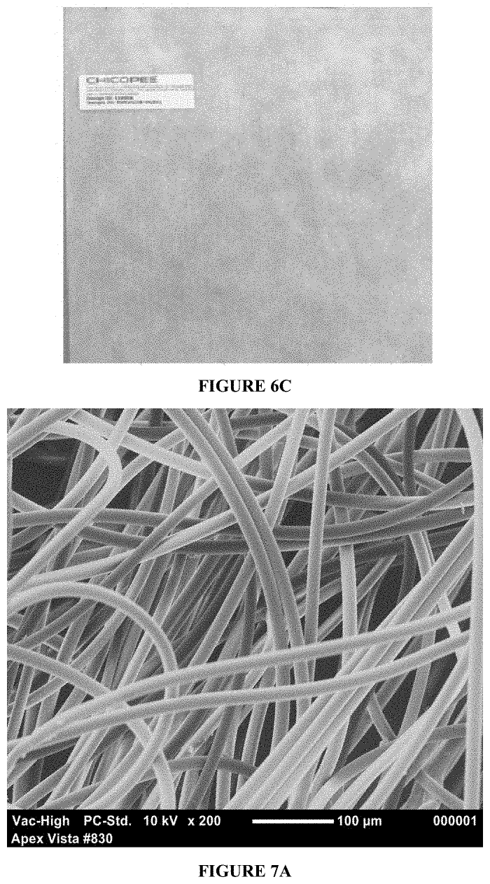

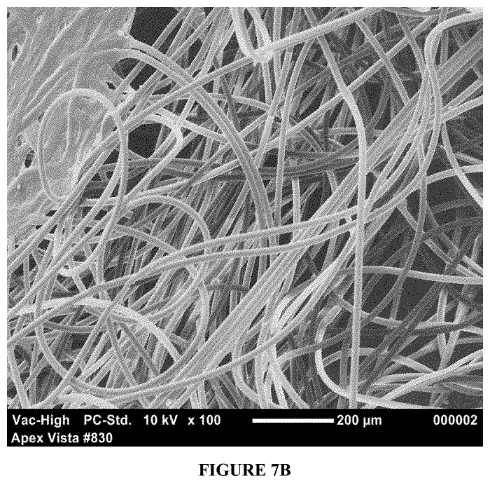

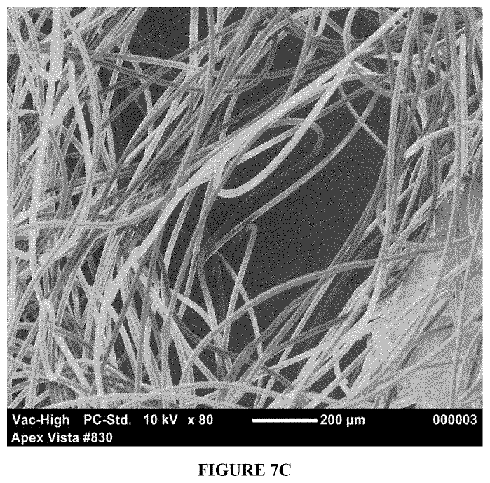

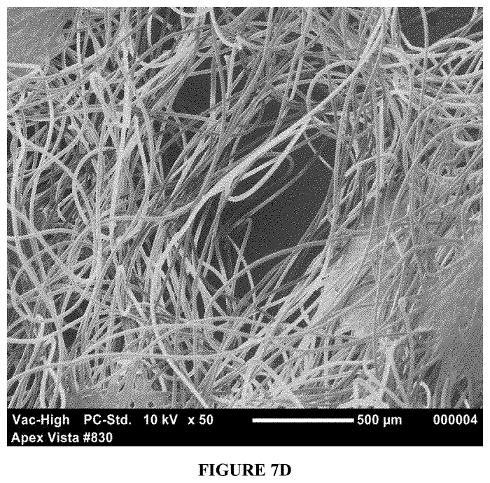

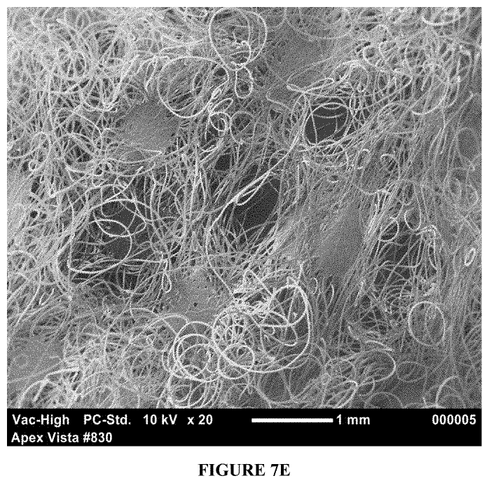

FIG. 6A shows an image of Sample 3. FIG. 6B shows an image of Sample 4. FIG. 6C shows an image of Sample 5. Upon comparison of FIGS. 6A-6C, the nonwoven fabric in accordance with certain embodiments of the invention (i.e., FIG. 6A) exhibit a strikingly crisper and more detailed three-dimensional image imparted thereon. FIGS. 7A-7E show magnified images of Sample 3 at varying scales, which are shown in each of the figures. As shown in FIGS. 7A-7E, the nonwoven fabric of Sample 3 includes a plurality of CCFs with several helically-shaped crimped portions.

TABLE 1

| | | | | Higher | | | |
|---|---|---|---|---|---|---|---|
| | Higher | Lower | Lower | Value is | | | |
| | Value is | Value is | Value is | indicative | | | |
| | indicative | indicative | indicative | of being | 0.5 kpa | | |
| | of being | of being | of being | Less Stiff | thickness | | |
| | Softer | Softer | Softer | D | Caliper | Grammage | Density |
| | HF | TS7 | TS750 | [mm/N] | (μm) | (g/m²) | (g/cm³) |
| Sample 1 | 27.0 | 3.765 | 5.867 | 4.51 | 1182 | 40 | 0.034 |
| Sample 2 | 52.0 | 2.386 | 5.687 | 3.68 | 831 | 40 | 0.048 |
| Sample 3 | 42.1 | 2.409 | 3.586 | 4.41 | 979 | 40 | 0.041 |
| Sample 4 | 69.3 | 5.225 | 7.107 | 1.89 | 499 | 40 | 0.080 |
| Sample 5 | 73.3 | 4.589 | 5.207 | 2.16 | 461 | 38 | 0.082 |

As shown in Table 1, the thickness of the Sample 3, for example is almost twice that of Samples 4 and 5. Also the HF values of Samples 4 and 5 are particularly high, however they actually will delaminate in the layers, due to lack of entanglement, showing again the improvement realized by certain embodiments of the invention (e.g., Sample 3).

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A nonwoven fabric, comprising: a plurality of crimped continuous fibers (CCFs); wherein the CCFs are physically entangled together to define a consolidated nonwoven fabric.

2. The nonwoven fabric of claim 1, wherein the CCFs comprise spunbond fibers, meltblown fibers, or combinations thereof.

3. The nonwoven fabric of claim 1, wherein the CCFs comprise mono-component fibers, multi-component fibers, or combinations thereof.

4. The nonwoven fabric of claim 3, wherein the CCFs comprise multi-component fibers comprising (i) a first component comprising a first polymeric material having a first melt flow rate (MFR) of less than 50 g/10 min; and (ii) a second component comprising a second polymeric material that is different than the first component; wherein the CCFs comprises one or more three-dimensional crimped portions.

5. The nonwoven fabric of claim 1, wherein the CCFs comprises an average free crimp percentage from about 30% to about 300%.

6. The nonwoven fabric of claim 5, wherein the one or more three-dimensional crimped portions include at least one discrete zig-zag configured crimped portion, at least one discrete helically configured crimped portion, or a combination thereof.

7. The nonwoven fabric of claim 4, wherein the CCFs comprises a sheath/core configuration, a side-by-side configuration, a pie configuration, an islands-in-the-sea configuration, a multi-lobed configuration, or any combinations thereof.

8. The nonwoven fabric of claim 7, wherein the CCFs comprises a sheath/core configuration comprising an eccentric sheath/core configuration including a sheath component and core component; wherein the core component defines at least a portion of an outer surface of the CCFs having the eccentric sheath/core configuration.

9. The nonwoven fabric of claim 4, wherein the first polymeric material comprises a first polyolefin composition and the second polymeric material comprises a second polyolefin composition, a polyester, or a polyamide.

10. The nonwoven fabric of claim 1, wherein the CCFs include (i) a first group of CCFs having a first identifying feature comprising a first cross-sectional geometry, a first chemical construction, or a first free crimp percentage, and (ii) a second group of CCFs having a second identifying feature comprising a second cross-sectional geometry, a second chemical construction, or a second free crimp percentage; wherein the first identifying feature is different than the second identifying feature.

11. The nonwoven fabric of claim 10, wherein the first group of CCFs include a polyolefin as at least a portion thereof, and the second group of CCFs include a non-polyolefin as at least a portion thereof.

12. The nonwoven fabric of claim 1, further comprising a plurality of non-crimped fibers physically entangled together with the CCFs; wherein the plurality of non-crimped fibers comprises spunbond fibers, meltblown fibers, staple fibers, cellulosic fibers, or combinations thereof.

13. The nonwoven fabric of claim 1, further comprising a plurality of thermal bonds; wherein the CCFs include at least one crimped portion located between a first thermal bond and a second thermal bond.

14. The nonwoven fabric claim 1, further comprising a plurality of non-crimped fibers comprising a biopolymer; wherein the plurality of non-crimped fibers are physically entangled together with the plurality of CCFs.

15. The nonwoven fabric of claim 1, further comprising a three-dimensional image imparted into at least a first surface of the nonwoven; wherein three-dimensional image includes at least one recessed portion and at least one projecting portion.

16. A method of forming a nonwoven fabric, comprising:
(i) forming or providing a first nonwoven or first nonwoven web comprising a first plurality of randomly deposited crimped continuous fibers (CCFs); and
(ii) physically entangling the first plurality of randomly deposited CCFs.

17. The method of claim 16, further comprising (a) providing a three-dimensional image transfer device having an imaging surface, (b) supporting the first nonwoven or first nonwoven web on the imaging surface of the three-dimensional image transfer device, and (c) subjecting at least a first side of the first nonwoven or first nonwoven web to jets of fluid at a pressure sufficient to physically entangle the first plurality of randomly deposited CCFs and to impart a three-dimensional image into the nonwoven fabric.

18. The method of claim 17, further comprising superimposing the first nonwoven or first nonwoven web with at least a second layer of fibers prior to physically entangling the first plurality of randomly deposited CCFs.

19. The method of claim 16, wherein the second layer of fibers comprises a second plurality of randomly deposited CCFs, a second group of non-crimped fibers, or a combination thereof; and wherein the first plurality of randomly deposited CCFs and the second layer of fibers are physically entangled together.

20. The method of claim 19, further comprising superimposing (a) the first nonwoven or first nonwoven web, (b) the second layer of fibers, and (c) a third layer of fibers; wherein the third layer of fibers comprises a third plurality of randomly deposited CCFs, a third group of non-crimped fibers, or a combination thereof; and wherein the first plurality of randomly deposited CCFs, the second layer of fibers, and the third layer of fibers are physically entangled together; wherein the second layer of fibers is positioned between the nonwoven or first nonwoven web and the third layer of fibers, and wherein the second layer of fibers comprise cellulosic fibers.
